(19) United States
(12) Patent Application Publication
(10) Pub. No.: US 2005/0198193 A1
(43) Pub. Date: Sep. 8, 2005

(54) System, method, and apparatus for creating metadata enhanced media files from broadcast media

(76) Inventor: Jaakko Halme, Helsinki (FI)

Correspondence Address: Crawford Maunu PLLC;Suite 390, 1270 Northland Drive, St. Paul, MN, 55120, US

(21) Appl. No.: 10/778,015

(22) Filed: Feb. 12, 2004

(51) Int. Cl. G06F 15/16

(52) U.S. Cl. 709/217

(57) ABSTRACT

In one embodiment, metadata associated with broadcasting entities within a network is augmented with detailed data such as audio files, which may later be retrieved and shared with other users. A mobile terminal having broadcast tuning, audio recording, presence, Internet browsing, and/or Radio Data System (RDS) capability may gather detailed information concerning a broadcast through any one or all of these capabilities. The detailed information is then combined with audio snippets derived either from the RDS data, Internet download, or from audio recording equipment to form metadata enhanced, media files that may be associated with the broadcasting entity. The metadata enhanced media files may be subsequently perused and shared with other users, whereby the audio snippets may be played back to provide the users with enhanced sensory recall of the broadcasting entity.

### FIELD OF THE INVENTION

This invention relates in general to media file storage, and more particularly, to metadata enhanced media file storage.

### BACKGROUND OF THE INVENTION

The mobile communication industry has experienced a period of exceptional growth during the last several years. New service enablers such as the Multimedia Messaging Service (MMS), Java, and the Extensible Hypertext Markup Language (XHTML) will continue to enable compelling new services for consumers and new sources of growth for the mobile industry. The development of these mobile services will continue to grow by using consumer behavior, the business structure surrounding the mobile service domains and technology.

To insure successful take-up of the evolving mobile services, however, the consumers must be able to discover them and subsequently visit and share them once they are discovered. Currently, mobile browsing is the predominant method used by the mobile service consumer to find such services. Other methods, however, may also be employed to discover services available to the mobile user. Multiple information sources, such as presence servers and media broadcasts for example, may be accessed by the mobile terminal for other relevant information.

While information from multiple sources may be accessed in a synchronous fashion, i.e., contemporaneously, it is a deficiency in the prior art that prohibits the user from revisiting and sharing all of the collected information at some later date. One particular deficiency of the prior art may be illuminated, for example, by examining the interaction between a consumer of Amplitude Modulation (AM)/Frequency Modulation (FM) radio broadcasts and the corresponding data that is associated with the AM/FM broadcasts. In particular, a user is able to listen to an FM broadcast, while obtaining related information from, for example, the broadcast station's Web Site concerning: the current song playing, the performers of the song, the identity of the disk jockey, etc. If the user is interested in the Web Site, he may then “bookmark” the URL of the Web Site and is then given the opportunity to enter some descriptive text associated with the bookmark.

At a later date when the user is perusing his favorites folder, he may not appreciate details concerning the bookmarked URL representing the Web Site because information such as the type of music played by the corresponding AM/FM station and a sample of the particular song that caught the user's attention is not available with the bookmark. Still further, if the user wishes to share such information with another user, the shared user may have even less of an appreciation for the URL's content, due to the missing descriptive data associated with the URL.

Accordingly, there is a need in the communications industry for a system, method, and apparatus that facilitates an ability to access numerous sources of information, e.g., URLs, media broadcasts, presence information, etc., while providing the ability to collect the information for later access and sharing.

### SUMMARY OF THE INVENTION

To overcome limitations in the prior art, and to overcome other limitations that will become apparent upon reading and understanding the present specification, the present invention discloses a system, method, and apparatus for facilitating enhanced metadata storage, such as through the use of audio files, that are to be associated with broadcast media.

In accordance with one embodiment of the invention, a system for creating metadata enhanced data objects associated with a broadcasting entity of a network comprises a network terminal coupled to the network. The network terminal comprises data acquisition modules adapted to receive information associated with the broadcasting entity and to form data objects from the information received and data exchange modules adapted to share the data objects with other network terminals within the network. The system further comprises a broadcast entity coupled to the network and adapted to provide broadcast data to the network terminal. The data acquisition modules are adapted to combine the broadcast data with the data objects to form metadata enhanced data objects for subsequent access by the network terminal and the other network terminals.

In accordance with another embodiment of the invention, a mobile terminal is wirelessly coupled to a network which includes a broadcast element capable of providing broadcast content within the network. The mobile terminal comprises a memory capable of storing at least an enhanced data processing module. The mobile terminal further comprises a processor that is coupled to the memory and configured by the enhanced data processing module to combine the broadcast content received from the broadcast element with data associated with the broadcast element to form metadata enhanced data objects. The mobile terminal further comprises a transceiver that is configured to facilitate exchange of the metadata enhanced data objects with a plurality of network elements that are also wirelessly coupled to the network.

In accordance with another embodiment of the invention, a computer-readable medium having instructions stored thereon which are executable by a mobile terminal for facilitating metadata enhanced data creation. The instructions perform steps comprising locating a broadcasting entity within a network and accessing data associated with the broadcasting entity. The data includes audio data generated by the broadcasting entity. The instructions further perform steps that comprise forming metadata enhanced data objects from the data. The steps further access the metadata enhanced data objects to facilitate playback of audio portions of the audio enhanced data objects, while also allowing sharing of the metadata enhanced data objects with other mobile terminals within the network.

In accordance with another embodiment of the invention, a method creates a metadata enhanced data object within a network. The method comprises locating a broadcast entity within the network, accumulating data associated with the broadcast entity. The data includes audio data generated by the broadcast entity. The method further comprises generating metadata enhanced data objects from the accumulated data.

In accordance with another embodiment of the invention, a system creates a metadata enhanced data object within a network. The system comprises a means for locating a broadcast entity within the network and a means for accumulating data associated with the broadcast entity. The data includes audio data generated by the broadcast entity. The system further comprises a means for generating audio enhanced data objects from the accumulated data, and a means for sharing the metadata enhanced data objects with terminals within the network.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, method, and apparatus in accordance with the invention.

### BRIEF DESCRIPTION OF THE DRAWINGS

The invention is described in connection with the embodiments illustrated in the following diagrams.

FIG. 1 is an exemplary communications network in accordance with the present invention;

FIG. 2 illustrates a functional block diagram of a mobile terminal in accordance with the present invention;

FIG. 3 illustrates an exemplary browsing session in accordance with the present invention;

FIG. 4 illustrates an exemplary block diagram of a proximity connection in accordance with the present invention;

FIG. 5 illustrates an exemplary flow diagram in accordance with the present invention;

FIG. 6 illustrates an alternate flow diagram in accordance with the present invention; and

FIG. 7 illustrates an exemplary mobile computing environment in accordance with the present invention.

### DETAILED DESCRIPTION OF THE INVENTION

In the following description of the exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, method and apparatus that allows a user of a landline or mobile terminal to store detailed information relating to received broadcast media that is to be subsequently accessed via a browser or other data access mechanism. During a typical media consumption session, for example, a user may listen to a broadcast transmission and notice something of particular interest concerning the broadcast being received. The user may then use his Internet browser as a user interface mechanism, in which the received broadcast and other metadata associated with the broadcast may be “bookmarked” into an enhanced media file and a related media clips file. Along with descriptive text to describe the media file, the user is allowed to enhance the utility of the media file by storing detailed metadata associated with the bookmark, which includes a recording of an audible portion of the received broadcast. Other detailed metadata may also be saved within the enhanced media file to include any number of data objects that are relevant to the received broadcast, such as track and album titles, composer, artist, and lyrics that may be associated with the recorded portion of the received broadcast, URLs associated with sales offices concerning the album titles, etc.

In one embodiment according to the present invention, the user, while listening to his favorite Amplitude Modulated/Frequency Modulated (AM/FM) broadcast, may hear something of interest and simultaneously visit the URL that may be associated with the AM/FM broadcast station and subsequently store the URL as a bookmark within the “favorites” folder of the browser's memory. Other information may be available from various other sources, such as from a Radio Data Service (RDS) utility, a presence server, or from the URL itself, that the user may wish to include with the bookmarked information. One such piece of information may include an audio snippet, i.e., audio recording of a portion of the song, that is “now playing”. The snippet may be generated locally by a recording device associated with the browsing terminal, downloaded from the AM/FM station's URL, or alternately received via the RDS channel on the FM broadcast. Once created, the audio snippet may then be saved along with other metadata associated with the bookmark for later access.

Bookmarking is only one user interface method employed by the present invention to store such media broadcast enhanced information, while other data storage/access methods may also be employed by the user to enhance his storage options. The user may implement, for example, an enhanced media file directory that may be accessed via a menu option of his terminal's front panel display. Once selected, previously recorded snippets associated with the enhanced media files may be presented to the user in a particular sorting order, such as for example, by song title or artist. The user may then highlight one of the previously recorded snippets to view other information, e.g., metadata, that was saved along with the snippet. The user may then have the option to “playback” the recorded snippet associated with the enhanced media file.

Later, the metadata enhanced media files may be shared with other users either proximately located to the sharing user or otherwise interconnected via wide area access means. Accordingly, various proximity technologies, such as Bluetooth, InfraRed, and Wireless Local Area Network (WLAN) may be used as the sharing medium. In other embodiments, packet switching technology, such as the General Packet Radio Service (GPRS), in conjunction with the Wireless Application Protocol (WAP), may be used to share the metadata enhanced media files with users of terminals that are not proximately located with the sharing terminal.

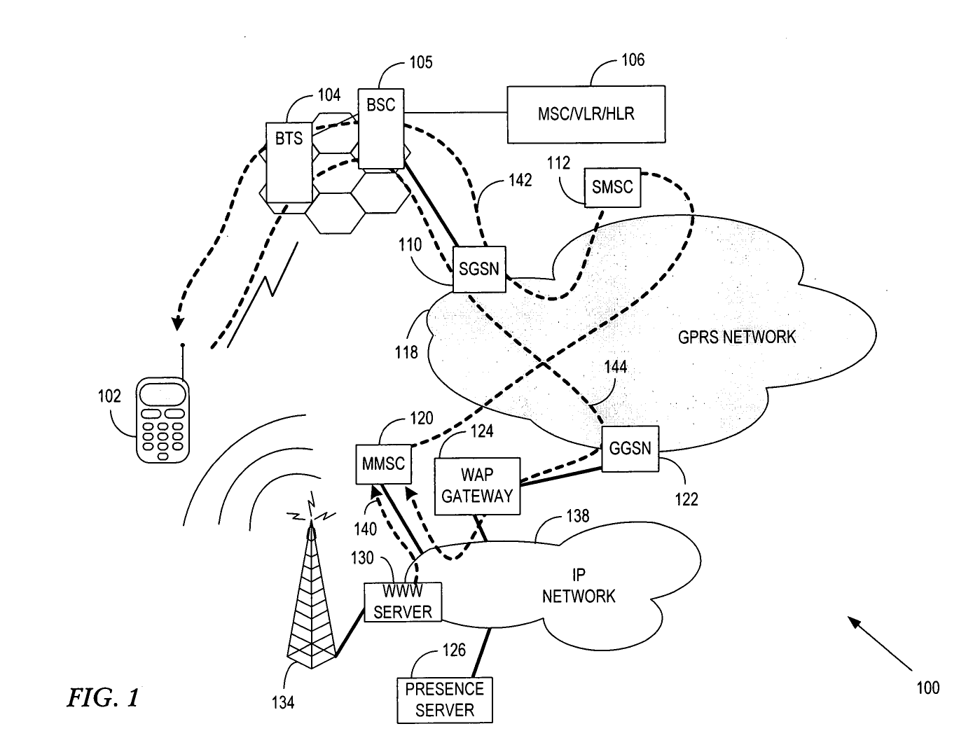

FIG. 1 illustrates exemplary communication network 100 that may be utilized in accordance with the present invention. GPRS is a packet-switched service for Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for WAP services. While the exemplary embodiments of FIG. 1 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Mobile terminal 102 communicates with Base Transceiver Station (BTS) 104 via an air interface. BTS 104 is a component of the wireless network access infrastructure that terminates the air interface over which subscriber traffic is communicated to and from mobile terminal 102. Base Station Controller (BSC) 105 is a switching module that provides, among other features, handoff functions, and power level control in BTS 104. BSC 105 controls the interface between a Mobile Switching Center (MSC) 106 and BTS 104, and thus controls one or more BTSs in the call set-up functions, signaling, and in the use of radio channels. BSC 105 also controls the respective interfaces between Serving GPRS Support Node (SGSN) 110 and BTS 104.

SGSN 110 serves a GPRS mobile terminal by sending or receiving packets via a Base Station Subsystem (BSS), and more particularly via BSC 105 in the context of GSM systems. SGSN 110 is responsible for the delivery of data packets to and from mobile terminal 102, within the service area, and performs packet routing and transfer, mobility management, logical link management, authentication, charging functions, etc. In the exemplary GPRS embodiment shown in FIG. 1, the location register of SGSN 110 stores location information such as the current cell and Visiting Location Register (VLR) associated with mobile terminal 102, as well as user profiles such as the International Mobile Subscriber Identity Number (IMSI) of all GPRS users registered with SGSN 110. SGSN 110 is ultimately coupled to SMSC 112 and/or MMSC 120 in connection with the presently described embodiment. While GSM forms the underlying technology, SGSN 110 described above is a network element introduced through GPRS technology. Another network element introduced in the GPRS context is the Gateway GPRS Support Node (GGSN) 122, which acts as a gateway between the GPRS network 118 and WAP gateway 124.

MMSC 120 provides messaging capabilities for the delivery of multimedia messages composed of text, photographs, video, and other media types. The messaging capabilities include mobile originated messages sent to other mobile terminals or applications and application originated messages sent to mobile terminals or other applications. MMSC 120 is responsible for storing incoming and outgoing MMS messages, as well as the transfer of messages between different messaging systems, such as an e-mail service. In addition, MMSC 120 may provide an External Application Interface (EAIF) (not shown) that allows application developers and service providers to connect to MMSC 120 to offer value added services to mobile subscribers, such as for example, presence information supplied by presence server 126 that is subscribed to by mobile terminal 102.

Tower 134 represents an AM/FM broadcast radio station having a transmission radius sufficient to reach mobile terminal 102. Mobile terminal 102, in addition to providing GPRS connectivity, also provides separate broadcast tuning capability. In other words, mobile terminal provides complete voice and messaging functionality through the primary media content channel enabled by its GPRS capability, but also provides a secondary media content channel enabled by its separate broadcast tuning capability. AM/FM radio station 134 also has Internet capability provided through WWW server 130. Thus, while AM/FM radio station 134 provides outbound AM/FM content to its listeners, e.g., mobile terminal 102, it may also interoperate within Internet Protocol (IP) network 138 through its Web page hosted by WWW server 130.

In particular, AM/FM radio station 134 may provide presence information to presence server 126 that may be of interest to mobile terminal 102. Such presence information may include: title of the “now playing” song of the broadcast; name of the artist performing the song; biographical information about the artist; other URLs that may be related to the “now playing” song; etc. When presence information provided by presence server 126 is combined with enhanced metadata in accordance with the present invention, a dynamic entity is created that naturally extends and enriches the functionality of the metadata enhanced media files. Thus, presence services offered by presence server 126 enables the gathering of detailed information that augments the versatility of media files, and other media broadcast enhanced data storage mechanisms, in accordance with the present invention.

AM/FM station 134 may also be equipped with facilities associated with the RDS. The RDS allows broadcast stations to transmit additional data that is multiplexed onto the same, or other, FM carrier that is used for the audio portion of the broadcast. The additional data may contain information concerning the current programming being transmitted, the station name, and other performance enhancing data. Thus, even in the absence of presence server 126, data may be collected by mobile terminal 102 from the RDS transmissions to similarly augment the versatility of media files, and other media broadcast enhanced data storage mechanisms, in accordance with the present invention.

As is discussed in more detail below, the mobile terminal may further increase the versatility of saved information through the use of local facilities associated with the mobile terminal itself. In particular, an audio recording device may exist within the mobile terminal that is capable of digitally recording an audio snippet of the “now playing” song transmitted by AM/FM station 134. In another embodiment, a digital version of the “now playing” audio snippet may be transmitted by AM/FM station 134 via its associated DAS utilities and subsequently processed by the mobile terminal. Still in another embodiment, the “now playing” audio snippet may be made available for download at WWW server 130 to any Internet browsers within IP network 138, or GPRS network 118, that may be able to access WWW server 130.

The audio snippet, e.g., .wav file, may then be stored along with the other detailed information gathered by the mobile terminal via, for example, presence server 126, or the data provided by the DAS facilities of AM/FM station 134. The audio snippet may then be recalled at a later time by the user of mobile terminal 102 and shared with other users. In such an instance, the user and other shared users may receive a full sensory perception of the audio enhanced information by, for example, “replaying” the audio snippet associated with the audio enhanced information.

With the aforementioned network system described as a representative network environment, a store and forward messaging scenario is now described in which a WAP push framework is utilized to store a message sent from WWW server 130 to MMSC 120, which is associated with, for example, presence information contained within presence server 126 relating to AM/FM station 134. Dashed line 140 represents the multimedia message flow from WWW server 130, which is ultimately posted to MMSC 120, which may have been a result of a previous WAP pull request from, for example, mobile terminal 102, since mobile terminal 102 may subscribe to presence information associated with AM/FM station 134. The WAP protocol suite is used as the data transport mechanism within GPRS network 118 because WAP provides data transport services that are optimized for mobile networks. WAP also provides uniform transport services regardless of the underlying network.

In particular, the Wireless Session Protocol (WSP) layer supplies the basis of the transport mechanism, in which MMS Protocol Data Units (PDU) are used to transport media content between, for example, mobile terminal 102 and MMSC 120. MMS Headers within the PDU mainly contain information as to how to transfer the PDU from the originator to the destination. The headers may contain such information as source unit identification, sink unit identification, message identification, content type, etc. The content type may be any content type supported by MMS such as images, or video, e.g., JPEG or GIF format; and text, e.g. plain or formatted text, to name only a few. HTTP encapsulation of the MMS PDUs are required when MMS messages are transported between, for example, WAP gateway 124 and MMSC 120. The message body of HTTP encapsulation comprises any number of binary encoded, Multipurpose Internet Mail Extensions (MIME) message parts.

Once the multimedia message has been transmitted to MMSC 120 by WWW server 130, an indication as to the content's receipt is provided to mobile terminal 102, which is denoted by dashed line 142. Notification 142 utilizes push semantics defined by the OMA, which delivers a receipt notification to the receiving device, e.g., mobile terminal 102, via for example, an SMS bearer and Short Message Service Center (SMSC) 112. The MMS PDU that is used to send the notification message within the push message is M-Notification.ind. The M-Notification.ind informs mobile terminal 102 about the contents of received message 140 and its purpose is to allow mobile terminal 102 to fetch multimedia message 140 from MMSC 120. The Notification PDU consists of MMS headers which define characteristics of the multimedia message such as: size of the multimedia message in octets; and the location of the multimedia message, e.g., MMSC 120. Once notification message 142 has been received, a WAP/GET operation, e.g. message 144, may either be automatically or manually initiated by mobile terminal 102 in order to receive the content specified by the Uniform Resource Identifier (URI) of notification message 142. Once the content has been received by mobile terminal 102, notification to the source is provided indicating successful receipt of the content, e.g., presence information associated with AM/FM station 134 received from presence server 126.

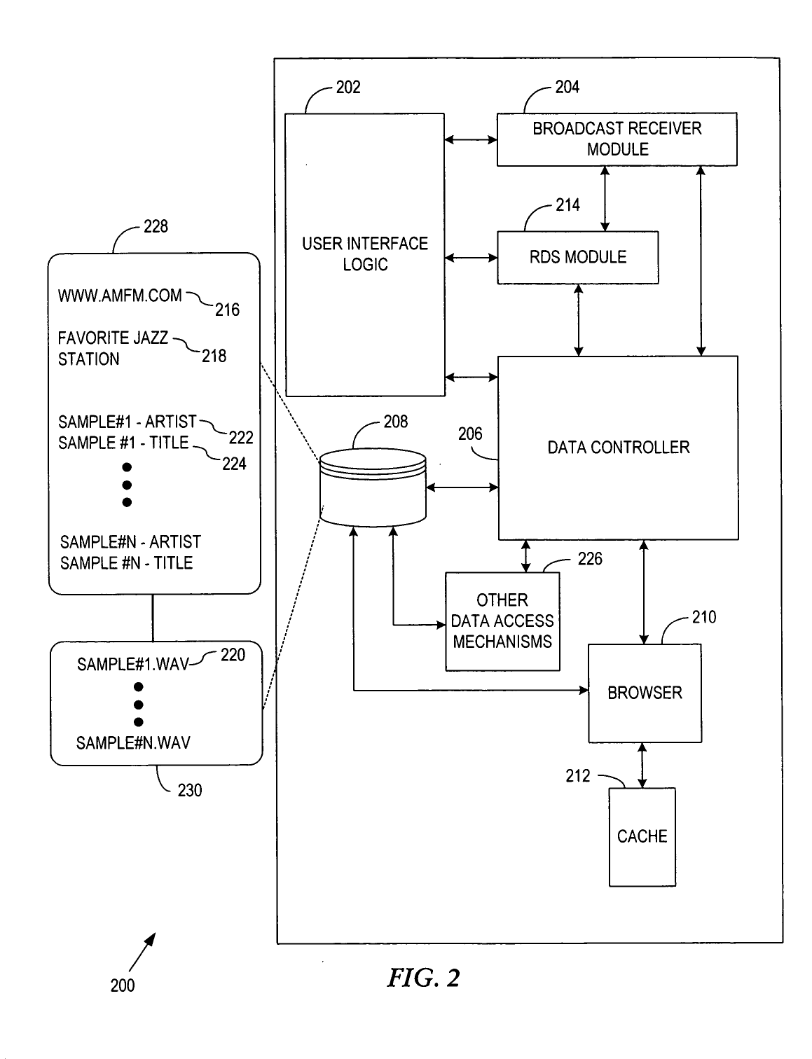

A block diagram of an exemplary mobile terminal in accordance with the present invention is presented in FIG. 2, whereby processing of AM/FM signals, DAS content, URL content, and presence data allows the user of the mobile terminal to create metadata enhanced, media files from broadcast media. In one embodiment, mobile terminal 200 automatically establishes a media content channel when the user of mobile terminal 200 tunes to a particular broadcast station transmitted by AM/FM radio station 134 of FIG. 1. User Interface (UI) logic block 202 is configured to allow the user of the mobile terminal to select AM/FM tuning functionality associated with broadcast receiver module 204. For example, the user may access preset broadcast channels from UI logic block 202 that causes broadcast receiver module 204 to tune its receiver in response to the particular broadcast channel selected by the user. The user of mobile terminal 200 is then free to enjoy the audible content that is generated by broadcast receiver module 204 in response to the tuning command issued by UI logic block 202.

Once the broadcast channel is selected, UI logic block 202 communicates the selected channel to data controller 206. Data controller 206 may be configured by the user through the use of UI logic block 202 to react in a number of different ways in response to the received AM/FM channel selection. In one embodiment, data controller 206 may automatically search database 208 for any corresponding user data that may be associated with the particular AM/FM channel selection. A URL, for example, may have been previously associated with the selected broadcast channel, such that data controller 206 causes browser 210 to contact the associated URL via WWW server 130 of FIG. 1, in response to the user's tuning command to the particular broadcast station.

Once contacted by browser 210, WWW server 130 downloads all content contained within the Web page pointed to by the URL to browser 210, via for example, the WAP Push framework discussed above, or alternatively via an HTTP/GET operation followed by an HTML reply. In one embodiment, browser 210 may be configured by UI logic block 202 to fully cache the contents of the Web page information into Cache 212, i.e., double-buffered mode, before display of the Web page contents takes place. Once fully loaded, browser 210 then transfers the contents from cache 212 to the display controller (not shown) of mobile terminal 200 for subsequent display to the user. In addition, browser 210 may be configured by UI logic block 202 to automatically perform a WAP pull operation from WWW server 130 at selected intervals.

Once the user views the contents of the URL associated with AM/FM station 134, he may then choose to “bookmark” the URL into the “favorites” directory of browser 210 contained within database 208 in accordance with one embodiment of the present invention. In another embodiment according to the present invention, other data access mechanisms 226 may alternately be used to create a media file along with other metadata relating to the media file, which may include a recording of a portion of the received broadcast to be placed into favorite audio clips folder 230. The user may, for example, instruct UI logic block 202 to access a digital snippet of the “now playing” song, so that digital snippet 220 may be saved into favorite media clips folder 230, while other metadata 216-218 and 222-224 is also saved within enhanced data storage location 228. Once saved, data relating to portions of the metadata, e.g., artist name 222 and song title 224, are linked to the corresponding media clip 220 for subsequent recall. Additionally, the metadata and linked media files may also be shared with other mobile terminals.

Digital snippet 220 may be obtained in any number of ways according to the present invention. In a first embodiment, digital snippet 220 may be obtained by engaging a recording device (not shown) within data controller 206 to record a portion of the “now playing” song that is currently being demodulated by broadcast receiver module 204. Once the recording has completed, the digital snippet may then be provided to database 208 for subsequent storage within favorite media clips folder 230. In an alternate embodiment, AM/FM station 134 may transmit digital snippets of “now playing” songs within its RDS broadcast. In such an instance, RDS module 214 may detect the presence of the snippet and subsequently capture it for future storage within database 208 via data controller 206. In an alternate embodiment, the digital snippet may be downloaded from WWW server 130 via browser 210 for subsequent storage into cache 212 and database 208.

In other embodiments, detailed information 222 and 224, e.g., concerning the artist and title associated with digital snippet 220, may either be derived from, for example, RDS broadcasts, URL content, or through presence information received as a result of a subscription to a presence service associated with AM/FM station 134. As subsequent songs are broadcast from AM/FM station 134, the user of mobile terminal 200 may instruct data controller 206 via UI logic block 202 to append the digital snippets, e.g., SAMPLE #N.WAV, and associated information, e.g., SAMPLE #N—ARTIST and SAMPLE #N—TITLE, to favorite media clips folder 230 and enhanced data storage location 228, respectively.

As such, the user is then able to return to enhanced data storage location 228 via browser 210, whereby prior to visiting URL 216, he may instead instruct data controller 206 to “playback” any of the digital snippets of songs located in favorite media clips folder 230 that are linked to enhanced data storage location 228. In such an instance, previously recorded/captured media clips, e.g., 220, associated with other metadata, e.g., 222 and 224, may be experienced by the user in order to make a final decision as to whether he wishes to visit URL 216. Other metadata, such as URLs associated with Internet Web sites that sell music performed by artist 222 for example, may also be saved within enhanced data storage location 228 to facilitate a buying option to the user if the “playback” of the media clip interests him.

Alternatively, the user may access favorite media clips folder 230 via other data access mechanisms 226, whereby for example, menu selections from UI logic block 202 provide direct access to favorite media clips folder 230. Favorite media clips folder 230 provides previously recorded media clips, e.g., 220, as indexed entries of favorite media clips folder 230. Once a particular media clip is selected, the corresponding metadata, e.g., 216, 218, and 222, may then be displayed to the user while the previously recorded snippet, e.g., 220, is “played back” to the user.

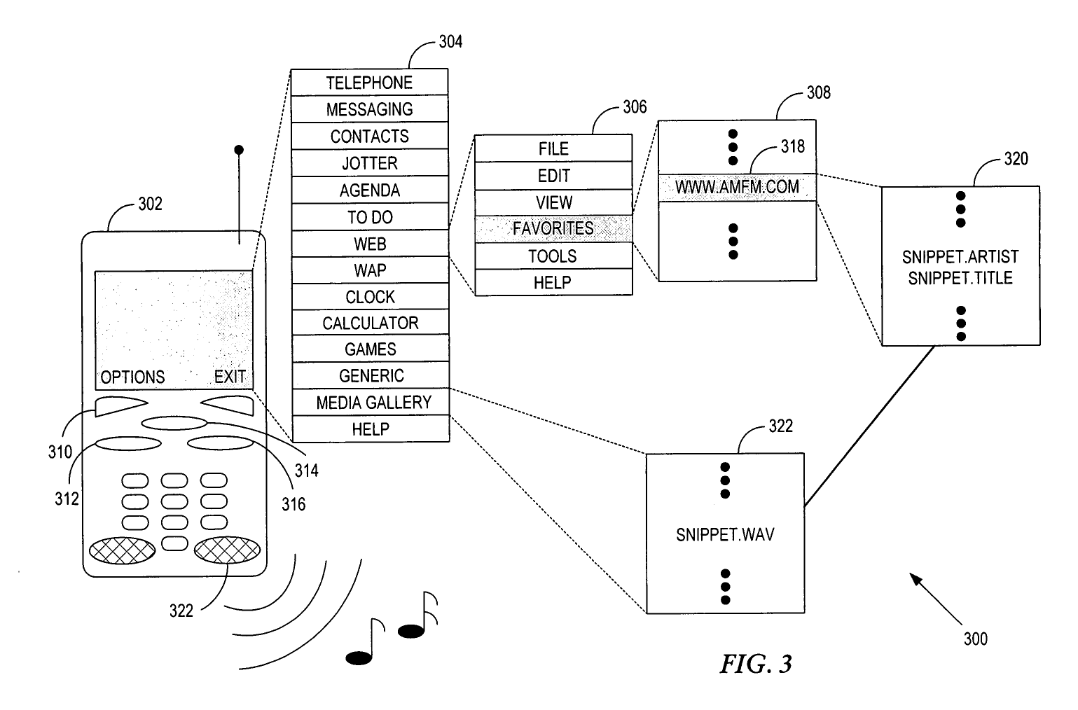

Browsing session 300 of FIG. 3 illustrates exemplary menu options that may be executed by a typical user when perusing entries within favorites folder 308 and media gallery 322 to access enhanced data storage location 228 and favorite media clips folder 230, respectively. The user of mobile terminal 302 navigates through sub-menus 304 and 306 before arriving at sub-menu 308, e.g., the bookmarked favorites sub-menu, in order to obtain previously saved enhanced metadata 320 associated with URL 318. By pressing navigational key 310 once, sub-menu 304 pops up to allow user interaction with the various options of sub-menu 304. By pressing either up key 312 or down key 316, one of the many options of sub-menu 304 may be highlighted and ultimately selected by pressing select key 314.

For example, once sub-menu 304 is instantiated, option “TELEPHONE” may be the default option of sub-menu 304, whereby 6 key presses of down key 316 highlights option “WEB”. One key press of select key 314 instantiates the “WEB” sub-menu 306, followed by 4 subsequent key presses of down key 316 highlights option “FAVORITES” of WEB sub-menu 306. One press of select key 314 instantiates “FAVORITES” sub-menu 308, that allows the user to then select URL 318 through an appropriate number of presses of down key 316 followed by a depression of selection key 314. Prior to visiting URL 318, the user of mobile terminal 302 may then select navigational key 310, which allows the user to view enhanced metadata 320 associated with URL 318. Once enhanced metadata 320 has been activated, the corresponding media clips of media gallery 322 are also made available to the user.

In particular, a media broadcast file, e.g., “SNIPPET.WAV”, exists within media gallery 322 that represents an excerpt of the “now playing” song that was being broadcast by AM/FM station 134 of FIG. 1 at the time that enhanced metadata 320 was saved into the appropriate favorites folder associated with URL 318. In accordance with the present invention, the user of mobile terminal 302 is then able to audibly sample the “SNIPPET.WAV” file by causing the “SNIPPET.WAV” file to be “replayed” through speakers 322. In addition, the user may experience any of the other enhanced metadata 320 that may exist prior to making the decision to visit URL 318. Alternately, the user may directly access media gallery through appropriate navigational commands within sub-menu 304, which then provides the user with the associated enhanced metadata 320 as applicable.

In one embodiment according to the present invention, enhanced metadata 320 and associated media clips 322 may be shared with other mobile terminals using, for example, the MMS messaging architecture as discussed above in relation to FIG. 1. In particular, browser settings, browser bookmarks 318, enhanced metadata 320, and media clips of media gallery 322 may be provided to other mobile terminals via the Over the Air Settings Specification (OASS). The browser settings are used to provide other mobile terminals with the basic setting needed to establish a connection to be used for mobile browsing. Browser settings are identified by the MIME type application/x-wap-prov.browser-settings. Similarly, browser bookmarks are used to provide bookmarks of any kind, e.g., bookmark 318 and associated enhanced metadata 320, and they are identified by the MIME type application/x-wap-prov.browser-bookmarks.

The browser settings and browser bookmarks are sent over the air in a binary encoded XML document with the specific MIME types discussed above depending upon the setting type, e.g., browser settings or browser bookmarks. The settings are pushed over SMS to a predefined Wireless Description Protocol (WDP) port, e.g., 49999, as a WSP connectionless un-secure push. The other mobile terminals wishing to share the browser settings and browser bookmarks with mobile terminal 302 should listen on this port for the shared information. Other methods of wide area sharing may be utilized, such as via MMS, email, or enhanced Instant Messaging (IM), and thus are not necessarily limited to the OASS.

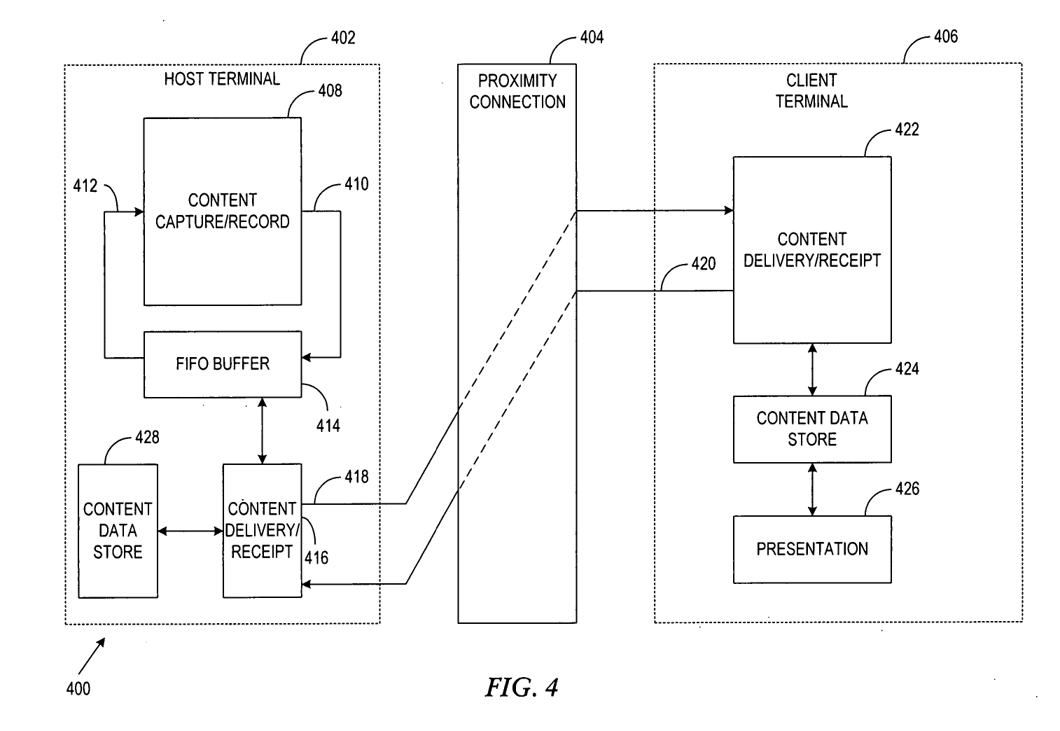

In an alternative embodiment, a proximity connection may be utilized in order to share enhanced metadata 320. Block diagram 400 of FIG. 4 illustrates host terminal 402 that is arranged to transfer data to client terminal 406 via path 418 and is arranged to receive acknowledgment of the received data via path 420. The nature of the data transfer may be of any type and rate that is supported by proximity connection 404, host terminal 402 and client terminal 406. One of ordinary skill in the art will recognize that any data type may be supported by such an arrangement. The data, for example, may be synchronization data that is transferred by host terminal 402 to client terminal 406 in order to obtain a common data store between the two devices via a data synchronization standard such as SyncML. The synchronization data may support such activities as calendar synchronization, contact synchronization, to-do lists, metadata enhanced media file synchronization, etc., as required between host terminal 402 and client terminal 406 to provide such a common data store. SyncML may also support data types such as images, files and database objects.

For purposes of exemplifying the present invention, block diagram 400 is discussed in terms of a content transport mechanism between host terminal 402 and client terminal 406, whereby proximity connection 404 is utilized as the communication conduit between the two devices. Proximity connection 404 may represent a wired and/or a wireless connection. Wired implementations of proximity connection 404 may include single ended data transmission formats such as those specified by the RS232 or RS432 standards, or may include differential data transmission formats such as those specified by the RS422 or RS485 standards. Other wired implementations for higher bandwidth considerations may use the Universal Serial Bus (USB), or FireWire, specifications for example. Wireless implementations of proximity connection 404 may include Wireless Local Area Network (WLAN), Bluetooth, Infrared, etc. as required by the particular application.

In one embodiment according to the present invention, host terminal 402 may have previously captured detailed data, such as media broadcast content via, for example, the RDS, URL download, or recording operation as discussed above, using content capture/record block 408. In such an embodiment, host terminal 402 may provide the detailed data to one or more client terminals 406, where content data store 428 contains the detailed data previously captured or recorded. In an alternate embodiment, real time transfer may occur between host terminal 402 and client terminal 406, whereby media broadcast content captured/recorded by host terminal 402 may be stored into content data store 428, while simultaneously being downloaded to client terminal 406.

In either case, content transfer is facilitated by using content delivery/receipt blocks 416 and 422 to manage the data transfer via path 418/420 through proximity connection 404. In addition to media broadcast file, e.g., SAMPLE#1.WAV 220 of FIG. 2, other data types such as text, images, ring tones, etc., incorporated within detailed data 228 associated with bookmark 216 may also be transferred via proximity connection 404 and subsequently stored within content data store 424. Subsequent to the data transfer with host terminal 402, client terminal 406 may then employ a browsing session similar to that illustrated in FIG. 3 to locate the newly shared enhanced metadata 320 now existent within its browser memory. In such an instance, any portion of enhanced metadata 320 may be experienced, e.g., through “playback” of SNIPPET.WAV, by the user of client terminal 406 before actually visiting URL 318.

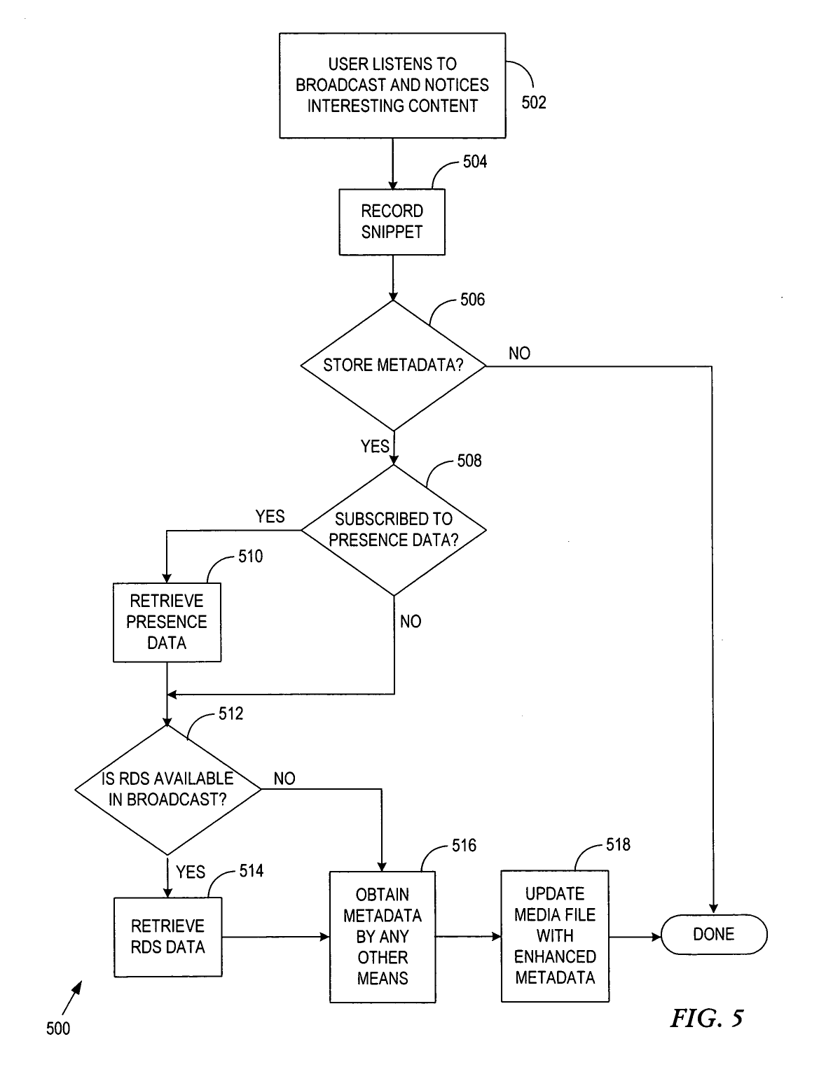

Generally, an exemplary method of locating, retrieving, and storing enhanced metadata in accordance with the present invention may be described using flow diagram 500 of FIG. 5. In step 502, the user of a mobile terminal is consuming an audio broadcast from a local broadcast station and discovers interesting content contained within the broadcast. While listening to the “now playing” song, a media broadcast snippet is obtained either through recording as in step 504, or downloaded via RDS or URL as discussed above. The user then decides to store the metadata associated with the received broadcast in step 506. Any presence data associated with the broadcasting entity that the user may have subscribed to is queried for availability in step 508. If presence data is available, then that presence data is retrieved from the appropriate presence server as in step 510 and cached for subsequent access as in step 518.

In addition, the broadcast channel carrying the audio signal is checked for RDS data availability as in step 512. If RDS data is available, then it is retrieved in step 514 from the multiplexed audio/data channel and cached for subsequent access as in step 518. Any other metadata is gathered in step 516 and formulated into a metadata enhanced media file as in step 518. Subsequent to the metadata enhanced media file operation, the enhanced media file may then be shared as discussed above via either proximity or wide area means.

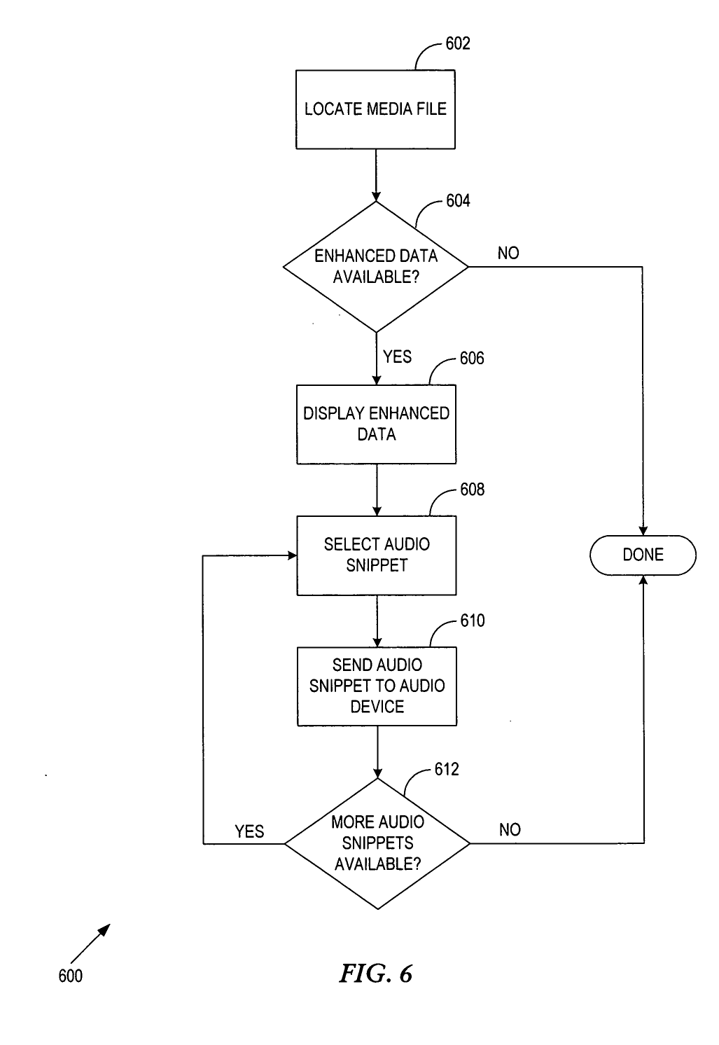

Flow diagram 600 of FIG. 6 may be used to illustrate an exemplary method that may be used to browse metadata enhanced media files that were previously saved in accordance with the present invention. In step 602, a previously saved media file and its associated metadata is located using a browser, or other data access mechanism, of a mobile terminal. If enhanced data, e.g., a media broadcast snippet or other enhanced data object, is available for viewing/experiencing as determined in step 604, then the enhanced data is displayed in step 606. Using navigational input to the mobile terminal, the user is provided the ability to select the particular enhanced data object of interest as in step 608. In the case that the enhanced data object is an audio snippet, the user may “replay” the audio snippet using an audio replay device associated with the mobile terminal as in step 610. If other audio snippets are available as determined in step 612, then they may similarly be selected and subsequently “played back” as in steps 608 and 610.

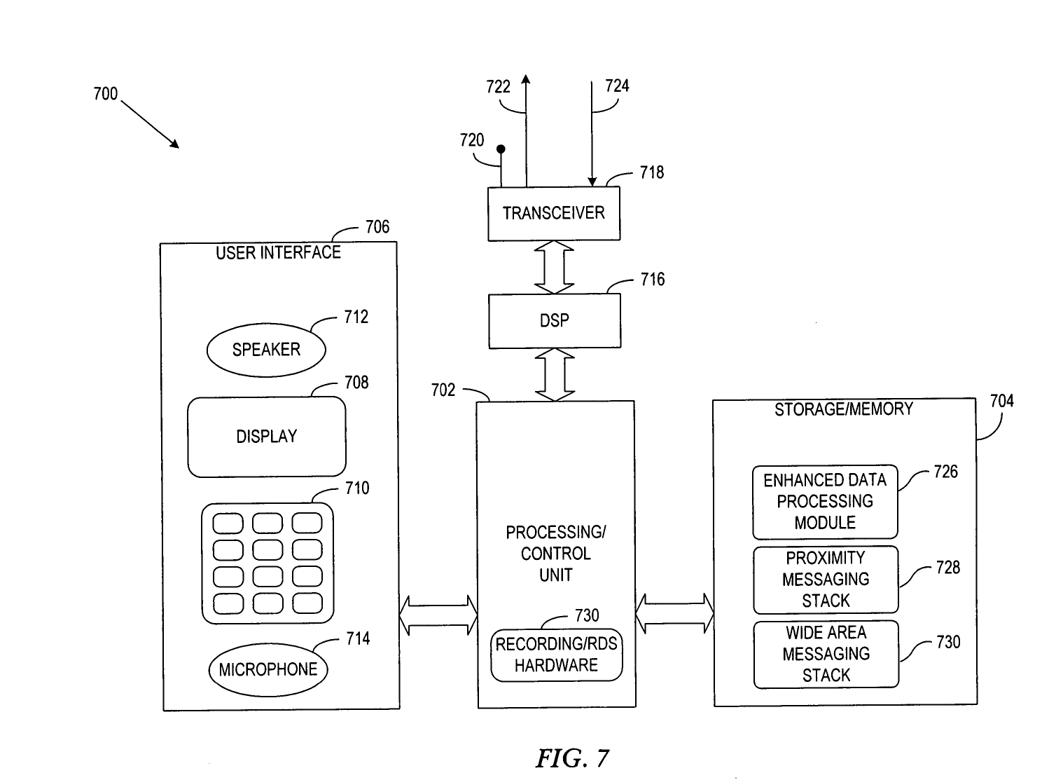

The invention is a modular invention, whereby processing functions within a mobile or landline terminal may be utilized to implement the present invention. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various enhanced data browsing/capture functions described herein. An example of a representative mobile terminal computing system capable of carrying out operations in accordance with the invention is illustrated in FIG. 7. Those skilled in the art will appreciate that the exemplary mobile computing environment 700 is merely representative of general functions that may be associated with such mobile devices, and also that landline computing systems similarly include computing circuitry to perform such operations.

The exemplary mobile computing arrangement 700 suitable for creating and sharing metadata enhanced media files in accordance with the present invention may be associated with a number of different types of wireless devices. The representative mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the mobile terminal, and also those functions associated with the present invention as dictated by enhanced data processing module 726, proximity messaging stack 728, and wide area messaging stack 730 in combination with recording/RDS hardware module 730. Thus, the processing unit 702, in conjunction with enhanced data processing module 726, is capable of accessing RDS and presence data associated with a particular broadcast of interest, and subsequently combining the data into a detailed data record in accordance with the present invention. Additionally, any audio data obtained through RDS or URL processing or through auxiliary AM/FM tuning equipment (not shown) may also be gathered/recorded and combined with the detailed record to create metadata enhanced media files that are then associated with the received broadcast. The program storage/memory 704 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 704 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The processor 702 is also coupled to user-interface 706 elements associated with the mobile terminal. The user-interface 706 of the mobile terminal may include, for example, a display 708 such as a liquid crystal display, a keypad 710, speaker 712, and microphone 714. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The mobile computing arrangement 700 also includes conventional circuitry for performing wireless transmissions. A digital signal processor (DSP) 716 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 718, generally coupled to an antenna 720, transmits the outgoing radio signals 722 and receives the incoming radio signals 724 associated with the wireless device.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create media broadcast enhanced data objects in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A system for creating metadata enhanced data objects associated with a broadcasting entity of a network, comprising:
a network terminal coupled to the network, the network terminal comprising:
data acquisition modules adapted to receive information associated with the broadcasting entity and to form data objects from the information received; and
data exchange modules adapted to share the data objects with other network terminals within the network; and
a broadcast entity coupled to the network and adapted to provide broadcast data to the network terminal, wherein the data acquisition modules are adapted to combine the broadcast data with the data objects to form metadata enhanced data objects for subsequent access by the network terminal and the other network terminals.

2. The system according to claim 1, wherein the data acquisition modules comprise a browser adapted to download the information from a Uniform Resource Locator (URL) associated with the broadcasting entity.

3. The system according to claim 1, wherein the data acquisition modules comprise a Radio Data Service (RDS) module adapted to receive the information from a broadcast channel of the broadcast entity.

4. The system according to claim 1, further comprising a presence server coupled to the network and adapted to provide presence information associated with the broadcast entity.

5. The system according to claim 4, wherein the data acquisition modules comprise a presence module adapted to receive the presence information from the presence server.

6. The system according to claim 1, wherein the data exchange modules comprise a messaging module adapted to provide the metadata enhanced data objects via a wide area connection.

7. The system according to claim 1, wherein the data exchange modules comprise a proximity module adapted to provide the metadata enhanced data objects to the other network terminals that are within a proximity of the network terminal.

8. The system according to claim 7, wherein the proximity module comprises one of a wired or a wireless module.

9. The system according to claim 8, wherein the wireless module comprises one of a Bluetooth, Wireless Local Area Network (WLAN), and an Infrared module.

10. The system according to claim 1, wherein the network terminal further comprises a data controller adapted to record the broadcast data provided by the broadcast entity.

11. The system according to claim 3, wherein the network terminal further comprises a data controller adapted to extract the broadcast data provided by the broadcast entity from the RDS broadcast.

12. The system according to claim 1, wherein the network terminal further comprises a data controller adapted to extract the broadcast data provided by the broadcast entity from the URL.

13. A mobile terminal capable of being wirelessly coupled to a network which includes a broadcast element capable of providing broadcast content within the network, the mobile terminal comprising:
a memory capable of storing at least an enhanced data processing module;
a processor coupled to the memory and configured by the enhanced data processing module to combine the broadcast content received from the broadcast element with data associated with the broadcast element to form metadata enhanced data objects; and
a transceiver configured to facilitate exchange of the metadata enhanced data objects with a plurality of network elements wirelessly coupled to the network.

14. The mobile terminal according to claim 13, wherein the enhanced data processing module is adapted to play back an audio portion of the metadata enhanced data objects accessed by an Internet browser associated with the mobile terminal.

15. The mobile terminal according to claim 13, wherein the transceiver is configured for proximity exchange with the plurality of network elements.

16. The mobile terminal according to claim 15, wherein the proximity exchange comprises a Bluetooth enabled exchange.

17. The mobile terminal according to claim 13, wherein the transceiver is configured for a wide area exchange with the plurality of network elements.

18. The mobile terminal according to claim 17, wherein the wide area exchange comprises a Multimedia Message Service (MMS) enabled exchange.

19. A computer-readable medium having instructions stored thereon which are executable by a mobile terminal for facilitating metadata enhanced data creation by performing steps comprising:
accessing data associated with a broadcasting entity, wherein the data includes audio data generated by the broadcasting entity;
forming metadata enhanced data objects from the data;
accessing the metadata enhanced data objects to facilitate playback of audio portions of the metadata enhanced data objects; and
sharing the metadata enhanced data objects with other mobile terminals within the network.

20. A method for creating a metadata enhanced data object within a network, comprising:
accumulating data associated with a broadcast entity, wherein the data includes audio data generated by the broadcast entity; and
generating metadata enhanced data objects from the accumulated data.

21. The method according to claim 20, wherein accumulating the data comprises downloading the data from a Uniform Resource Locator (URL) associated with the broadcast entity.

22. The method according to claim 20, wherein accumulating the data comprises deriving the data from a Radio Data System (RDS) broadcast from the broadcast entity.

23. The method according to claim 20, further comprising providing access to the metadata enhanced data objects with a plurality of terminals within the network.

24. A system for creating a metadata enhanced data object within a network, comprising:
means for accumulating data associated with a broadcast entity, wherein the data includes audio data generated by the broadcast entity;
means for generating metadata enhanced data objects from the accumulated data;
means for sharing the metadata enhanced data objects with terminals within the network.
